(19) United States
(12) Patent Application Publication
(10) Pub. No.: US 2017/0238586 A1
(43) Pub. Date: Aug. 24, 2017

(54) POPCORN TOPPING APPLICATOR

(71) Applicants: Salvatore Salpietro, Hollywood, FL (US); Martha Pinango, Fort Lauderdale, FL (US)

(72) Inventors: Salvatore Salpietro, Hollywood, FL (US); Martha Pinango, Fort Lauderdale, FL (US)

(21) Appl. No.: 15/051,162

(22) Filed: Feb. 23, 2016

(51) Int. Cl. A23L 7/191; A47G 23/00; A23P 20/15

(52) U.S. Cl. CPC A23L 7/191; A23P 20/15; A47G 23/00; A23V 2002/00

(57) ABSTRACT

A device for distributing melted butter flavoring, or other toppings intended for popcorn, homogenously throughout a mass of popcorn which comprises: a) a perforated tubular component and, preferably, b) a funnel component integral with an upper end of the perforated tubular component, wherein, when the perforated tubular component is inserted into the mass of popcorn, and liquid flavoring is poured into the upper end of the tubular component; e.g., the funnel component, it will flow out through the perforations in the tubular component and be distributed homogenously throughout the mass of popcorn.

### BACKGROUND OF THE INVENTION

Most consumers of popcorn prefer a flavored variety. When moviegoers purchase popcorn, it is traditionally provided in a tall bag or bucket, and most will also apply a butter flavored topping, or other type of flavorant, to the popcorn. In most cases, however, the means provided for application of the topping only distributes the flavorant to the top layer of the popcorn in the container, thus, leaving most of the popcorn unflavored.

Studies have shown that that 60% of the movie-going population view this lack of homogenous topping distribution as the #1 problem with popcorn consumption. There is, at present, nothing on the market that addresses this common complaint.

It is an object of the present invention to provide a system that enables the homogenous distribution of topping or flavoring throughout a mass of popcorn.

### SUMMARY OF THE INVENTION

The above and other objects are realized by the present invention, one embodiment of which comprises a device for distributing melted butter flavoring, and other popcorn toppings, homogenously throughout a mass of popcorn which comprises: a) a perforated tubular component and, preferably, b) a funnel component integral with an upper end of said perforated tubular component, wherein, when said perforated tubular component is inserted into the mass of popcorn, and melted butter flavoring, or other liquid topping, is poured into the funnel component, it will flow out through the perforations in the tubular component into the mass of popcorn.

These and other features, aspects and advantages of the present invention will become better understood with reference to the following drawings, description and claims.

### BRIEF DESCRIPTION OF THE DRAWINGS

FIG. 1 is a cross-sectional elevation view of the invention in use.

FIG. 2 is a perspective view of the invention.

FIG. 3 is an elevation view of the invention.

FIG. 4 is a cross-sectional view taken on line 4-4 of FIG. 3.

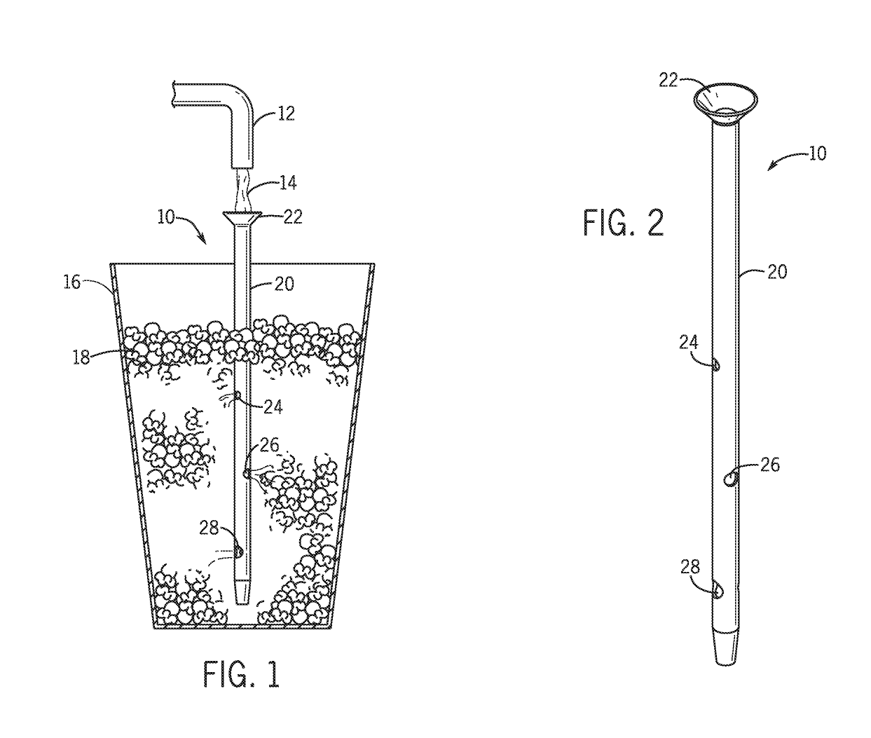

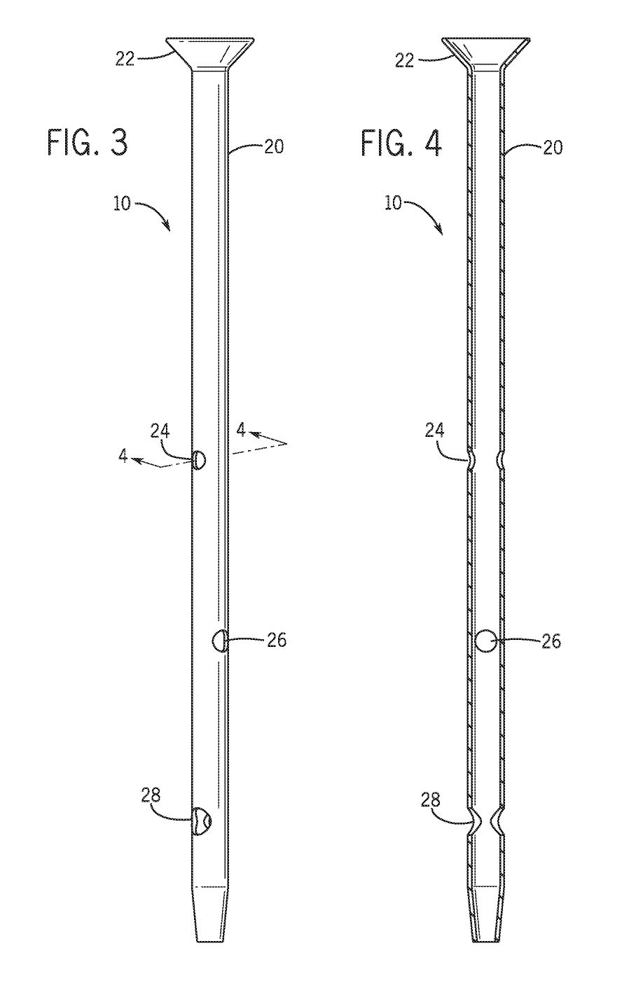

### DETAILED DESCRIPTION OF THE INVENTION

The following detailed description is the best currently contemplated mode of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device for distributing melted butter flavoring, or other toppings intended for popcorn, homogenously throughout a mass of popcorn which comprises: a) a perforated tubular component and, preferably, b) a funnel component integral with an upper end of the perforated tubular component, wherein, when the perforated tubular component is inserted into the mass of popcorn, and liquid flavoring is poured into the upper end of the tubular component; e.g., the funnel component, it will flow out through the perforations in the tubular component and be distributed homogenously throughout the mass of popcorn.

Referring to the drawings which depict a preferred embodiment of the invention, the popcorn flavor topping applicator 10 of the invention comprises tubular element 20, which is provided at its upper end with funnel element 22, and along its length with multiple perforations 24, 26, and 28. The funnel element 22 is shaped to mate with a nozzle 12 which emits melted butter flavoring or other topping 14 from its container source (not shown). When the tubular element 20 is immersed into a mass of popcorn 18 held within a container 16, and melted butter flavoring or other flavor topping 14 is emitted from nozzle 12 into the funnel element 22, the melted flavoring travels downward via gravity through the tubular element 20 and out through perforations 24, 26, and 28 into the mass of popcorn 18. The invention includes any size or shape of any of the elements described above.

It will be understood by those skilled in the art that the invention also embraces the following embodiments:

The tubular element 20 and funnel element 22 may be constructed from the same or different materials, which include but are not limited to suitable plastics, metals, and paper. It will be understood by those skilled in the art that the tubular element may assume a variety of shapes and sizes. Thus, it may be perfectly cylindrical or polygonal. Moreover, its diameter need not be the same throughout the entire length of the element. For example, it may be narrowed at one or more locations in order to slow down the rate of passage of liquid flavorant in the devise and optimize the distribution thereof throughout the mass of popcorn.

The melted butter flavoring or other topping 14 may comprise butter or any of the conventional synthetic butter flavorants. The melted butter flavoring may also include salt or any other compatible flavor adjuvant. Or may also be of a different flavor completely, but of a similar consistency and viscosity of butter flavored topping.

Those skilled in the art will also appreciate that the tubular element 22 may be provided with any suitable number of perforations, and that they may be spaced along the tubular element in any desired pattern; although a pattern of regularly spaced perforations will ensure a more homogenous distribution of melted butter flavoring or other topping throughout the mass of popcorn. Moreover, the perforations 24, 26, and 28 need not all be of the same size.

The funnel element 22 may assume any suitable conical or polygonal shape or size not inconsistent with the melted butter flavorant or other topping being able to flow therefrom into the tubular element.

The invention also contemplates the funnel element 22 being provided with means for securing it to the nozzle 12, such as an adhesive pad, to facilitate dispensing of the melted butter flavoring therefrom.

The lower end of tubular element 20 may be beveled or pointed to facilitate penetration into the mass of popcorn 18. In addition, the lower end may also be open to permit the distribution of melted butter flavoring or other topping 14 therefrom.

Moreover, the device of the invention may be provided with indicia such as advertisements, instructions for use, and the like.

Although the drawings and the above description are directed to a preferred embodiment of the invention, it will be understood that the various elements of the device may comprise any shape or size not inconsistent with the function thereof, which is to enable the user/popcorn consumer to distribute butter flavoring or other topping into and throughout a container of popcorn, with various points of application of the flavorant, and is designed to work with existing nozzles and butter topping machines with minimal mess.

It should be understood, of course, that the foregoing relates to exemplary embodiments of the invention and that modifications may be made without departing from the spirit and scope of the invention as set forth in the following claims.

What is claimed is:

1. A device for distributing melted butter flavoring homogenously throughout a mass of popcorn which comprises: a perforated tubular component, wherein, when said perforated tubular component is inserted into the mass of popcorn, and melted butter or other liquid flavoring is poured into the upper end of the component, it will flow out through the perforations in the tubular component into the mass of popcorn.

2. The device of claim 1 additionally comprising a funnel component integral with the upper end of said tubular component.

3. The device of claim 1 wherein said tubular component is cylindrical or polygonal in shape.

4. The device of claim 3 wherein said funnel component is cylindrical or polygonal in shape.

5. The device of claim 1 wherein said tubular component is provided with multiple perforations.

6. The device of claim 2 wherein said multiple perforations are spaced uniformly, or non-uniformly, as desired, along and around said tubular component.

7. The device of claim 1 wherein said funnel has a conical or polygonal shape.

8. The device of claim 1 further including attaching means for securing said funnel component to a melted butter flavorant dispenser.

9. The device of claim 5 wherein said attaching means comprises an adhesive patch.

10. The device of claim 1 wherein said funnel element and tubular element are constructed of a material selected from the group consisting of metals, plastics, paper or combinations thereof.

11. The device of claim 1 wherein said tubular element is closed at the end distal from said end integral with said funnel.

12. The device of claim 1 wherein said tubular element is open at the end distal from said end integral with said funnel.

13. The device of claim 1 wherein the end of said tubular element distal from said end integral with said funnel is shaped so as to facilitate immersion thereof into a mass of popcorn.

14. The device of claim 1 provided with indicia.
